(19) United States
(12) Patent Application Publication
(10) Pub. No.: US 2022/0247871 A1
(43) Pub. Date: Aug. 4, 2022

(54) IMAGING DEVICE CONFIGURED TO PROCESS ENTRIES IN A DISTRIBUTED LEDGER

(71) Applicant: KYOCERA DOCUMENT SOLUTIONS INC., Osaka (JP)

(72) Inventor: Eric Louis KAMPMAN, Albany, CA (US)

(73) Assignee: KYOCERA DOCUMENT SOLUTIONS INC., Osaka (JP)

(21) Appl. No.: 17/165,235

(22) Filed: Feb. 2, 2021

(51) Int. Cl. H04N 1/00

(52) U.S. Cl. CPC H04N 1/0088; H04N 1/00867

(57) ABSTRACT

An imaging device includes a distributed ledger. Image files are generated by the imaging device. Data for the image files are added to a partial chain hash. When a condition is met by the data with the partial chain hash, a new block is generated for the distributed ledger using the partial chain hash and data from a block header of a previous block. The distributed ledger is used within a printing system. A printing device accessing the distributed ledger can print the images of the image files.

### FIELD OF THE INVENTION

The present invention relates to an imaging device along with associated methods to process entries in a distributed ledger. More particularly, the present invention relates to processing entries in a distributed ledger for an imaging device of files generated therein.

### DESCRIPTION OF THE RELATED ART

Imaging devices and systems keep expanding in scope. With remote networking and other such features, the management of documents over such networks involves an increasing amount of data as more files are created. The image captures for the documents and pictures also continue to increase such that management may become difficult as well as more security threats in the network. A document management system should track the documents files as well prevent tampering and provide validation for actions taken within the system using the imaging device.

### SUMMARY OF THE INVENTION

One aspect of the present disclosure relates to a system configured for processing image files at an imaging device using a distributed ledger. The system may include one or more hardware processors configured by machine-readable instructions. The processor(s) may be configured to generate a first image file using the imaging device. The first image file may include data. The processor(s) may be configured to determine a partial chain hash of the data for the first image file. The processor(s) may be configured to generate at least one additional image file having data using the imaging device. The processor(s) may be configured to update the partial chain hash with the data of the at least one additional image file. The processor(s) may be configured to generate a block having a block header for a blockchain using the partial chain hash when a condition is met. The image files may be transactions within the block. The processor(s) may be configured to send the block from the imaging device over a network.

Another aspect of the present disclosure relates to a method for processing image files at an imaging device using a distributed ledger. The method may include generating a first image file using the imaging device. The first image file may include data. The method may include determining a partial chain hash of the data for the first image file. The method may include generating at least one additional image file having data using the imaging device. The method may include updating the partial chain hash with the data of the at least one additional image file. The method may include generating a block having a block header for a blockchain using the partial chain hash when a condition is met. The image files may be transactions within the block. The method may include sending the block from the imaging device over a network.

Yet another aspect of the present disclosure relates to a non-transient computer-readable storage medium having instructions embodied thereon, the instructions being executable by one or more processors to perform a method for processing image files at an imaging device using a distributed ledger. The method may include generating a first image file using the imaging device. The first image file may include data. The method may include determining a partial chain hash of the data for the first image file. The method may include generating at least one additional image file having data using the imaging device. The method may include updating the partial chain hash with the data of the at least one additional image file. The method may include generating a block having a block header for a blockchain using the partial chain hash when a condition is met. The image files may be transactions within the block. The method may include sending the block from the imaging device over a network.

A method for processing data at an imaging device using a distributed ledger is disclosed. The method includes generating a first image file using the imaging device. The first image file includes data. The method also includes determining a partial chain hash of the data for the first image file. The method also includes generating at least one additional image file having data using the imaging device. The method also includes updating the partial chain hash with the data of the at least one additional image file. The method also includes generating a block having a block header for a blockchain using the partial chain hash when a condition is met. The image files are entries within the block. The method also includes updating the distributed ledger associated with the imaging device with the block.

A method for processing images captured by an imaging device is disclosed. The method includes generating a first image file and a second image file using the imaging device. The first and second image files include data. The method also includes concatenating the data for the first and second image file. The method also includes determining a partial chain hash of the concatenated data. The method also includes updating the partial chain hash with data of at least one subsequent image file. The method also includes generating a block having a block header for a blockchain using the partial chain hash when a condition is met. Each image file is an entry within the block. The method also includes updating a distributed ledger with the block. The imaging device and a printing device include the distributed ledger. The method also includes processing the image files at the printing device.

An imaging device is disclosed. The imaging device includes a lens and a charged-coupled device configured to captured images. The imaging device also includes a processor to convert the captured images into image files having data. The imaging device also includes a memory to store the image files. The memory also stores instructions to configure the processor to determine a partial chain hash of the data for a first image file. The processor also is configured to generate at least one additional image file having data. The processor also is configured to update the partial chain hash with the data of the at least one additional image file. The processor also is configured to generate a block having a block header for a blockchain using the partial chain hash when a condition is met. The image files are entries within the block. The processor also is configured to update a distributed ledger associated with the imaging device with the block.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

Various other features and attendant advantages of the present invention will be more fully appreciated when considered in conjunction with the accompanying drawings.

FIG. 1A illustrates a system having an imaging device and a printing device according to the disclosed embodiments.

FIG. 1B illustrates an imaging device having a distributed ledger according to the disclosed embodiments.

FIG. 1C illustrates blocks and entries in a distributed ledger for the imaging device according to the disclosed embodiments.

FIG. 1D illustrates a block diagram of the components of a printing device according to the disclosed embodiments.

FIG. 2A illustrates a computing platform configured for processing entries in a distributed ledger for a printing system according to the disclosed embodiments.

FIG. 2B illustrates modules of the computing platform according to the disclosed embodiments.

FIG. 2C further illustrates modules of the computing platform according to the disclosed embodiments.

FIG. 3 illustrates a flowchart for processing entries in a distributed ledger for an imaging device according to the disclosed embodiments.

FIG. 4 further illustrates a flowchart for processing entries in a distributed ledger for an imaging device in a printing system according to the disclosed embodiments.

### DETAILED DESCRIPTION OF THE PREFERRED EMBODIMENTS

Reference will now be made in detail to specific embodiments of the present invention. Examples of these embodiments are illustrated in the accompanying drawings. Numerous specific details are set forth in order to provide a thorough understanding of the present invention. While the embodiments will be described in conjunction with the drawings, it will be understood that the following description is not intended to limit the present invention to any one embodiment. On the contrary, the following description is intended to cover alternatives, modifications, and equivalents as may be included within the spirit and scope of the appended claims. Numerous specific details are set forth in order to provide a thorough understanding of the present invention.

The disclosed embodiments protect log-like data within system that generates the data using an imaging device, such as a scanner or a camera. The log-like data may relate to documents or transactions within the system. In a log or similar set of incremental entries, it may be important to detect tampering, such as tampering with the data captured by the imaging device. In limited computing resource situations, however, standard one blockchain record per entry may not be feasible. Thus, the disclosed embodiments provide a limited form of blockchain by constraining how many hashes are included in the data set, such as pictures or scan jobs. This feature may keep tampering detection in place, while sacrificing to some degree at what point that the tampering occurred.

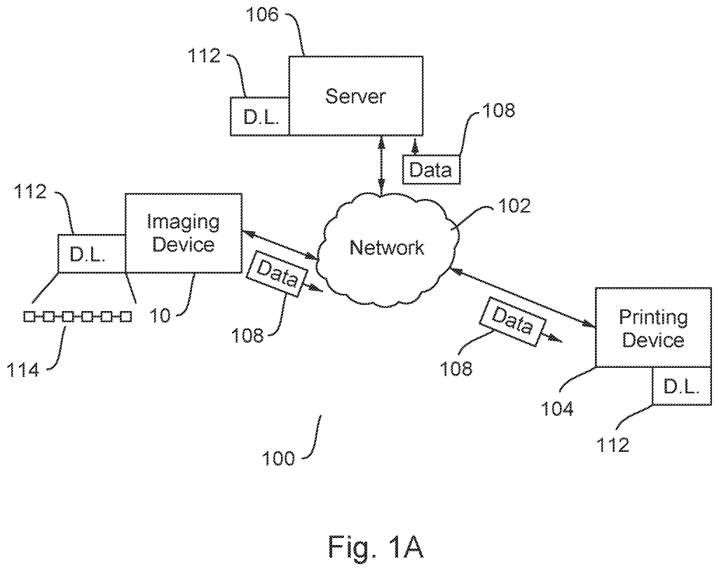

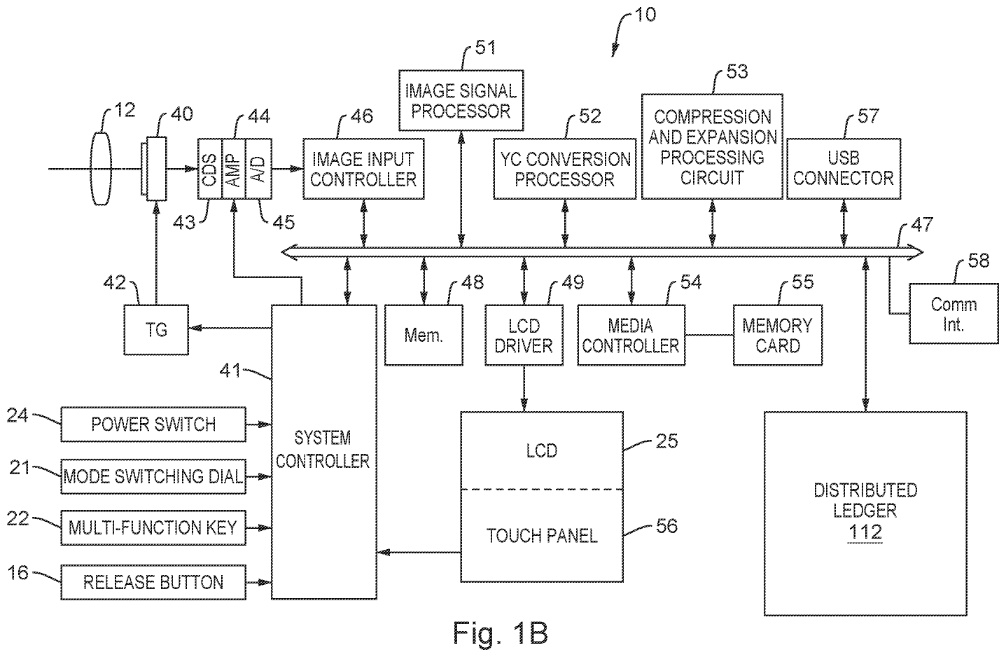

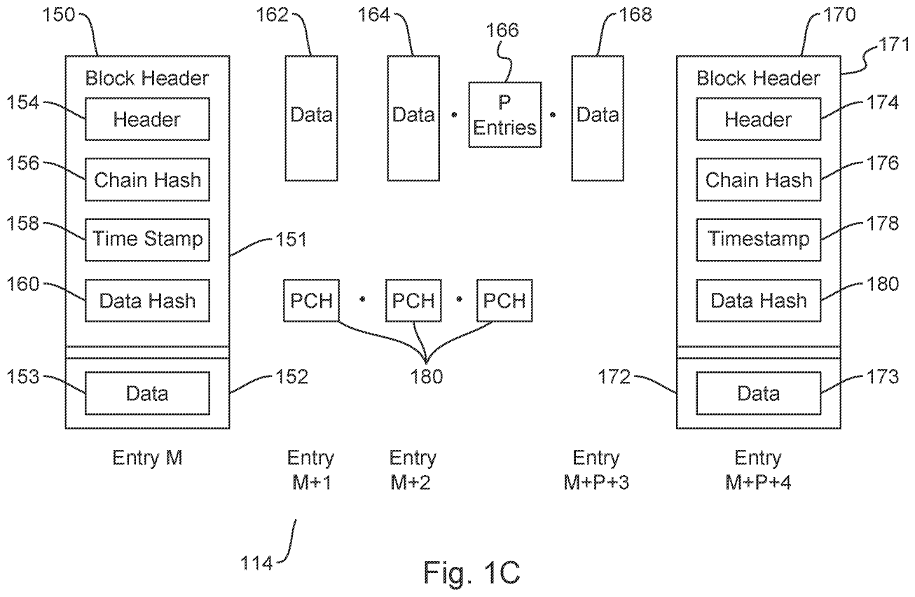

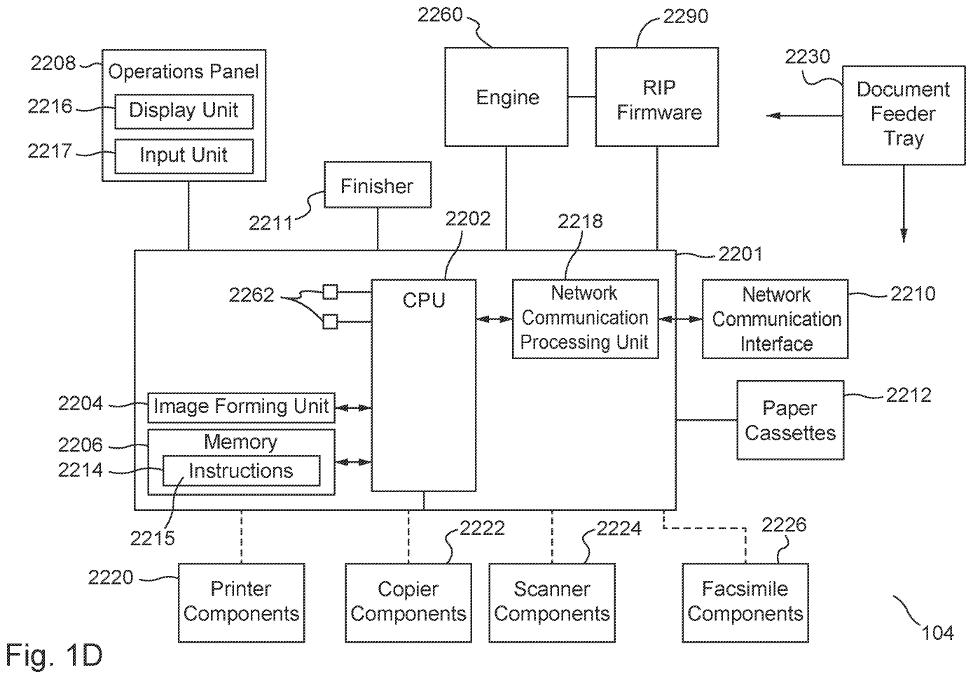

FIG. 1A depicts a block diagram of a system 100 having an imaging device 10 and a printing device 104 according to the disclosed embodiments. Printing system 100 may manage and facilitate data 108 captured by imaging device 10. Data 108 captured by imaging device 10, such as an image file, may be sent to other components within system 100, such as printing device 104 or server 106. In some embodiments, imaging device 10 is a camera that take pictures that are captured and stored thereon. The data related to the pictures may be sent over network 102 within system 100 to other components for processing, storage, printing, and the like. In other embodiments, imaging device 10 may be a scanner that captures the image file of a document. For example, imaging device 10 may be a component of printing device 104 in these instances. The image file of the document may be printed or stored at imaging device 10, printing device 104, or server 106.

Network 102 in system 100 may include one or more wired or wireless connections that support communication between the devices of system 100. In some embodiments, network 102 may support one or more communication protocols, such as Extensible Messaging and Presence Protocol (XMPP), File Transfer Protocol (FTP), HyperText Transport Protocol (HTTP), Java Message Service (JMS), Simple Object Access Protocol (SOAP), Short Message Service (SMS), Simple Mail Transfer Protocol (SMTP), Simple Network Management Protocol (SNMP), Transmission Control Protocol/Internet Protocol (TCP/IP), User Datagram Protocol (UDP), Lightweight Directory Access Protocol (LDAP), and the Message Queue (MQ) family of network protocols.

Network 102 is configured to allow communication between imaging device 10 and printing device 104 or server 106 within system 100, or between one or more other devices or systems and system 100. Such communications may include commands, requests, or data corresponding to documents, printing-device errors, or other data.

Printing device 104 may be configured to perform one or more functions such as printing, scanning, emailing, storing, modifying, receiving, or transmitting one or more documents or files. In some embodiments, each printing device may include hardware and software components associated with a firmware package. Firmware may refer to packages of software installed on embedded devices. Each firmware may include a version for the different packages for the components within the printing device. Printing device is disclosed in greater detail by FIG. 1D.

Server 106 may include a cloud-based server, for example, that can perform one or more tasks to manage or maintain printing devices within system 100. Server 106 may communicate with printing device 104 to transmit and receive data. Server 106 also may manage data and documents within system 100.

System 100 may store data in a blockchain 114 accessible via network 120. The data may be retrieved by those having access to the image files whether stored on the blockchain. Data stored in the blockchain may be printed at a printing device within system 100. The components shown in FIG. 1A may be considered blockchain nodes. A data reference may be a unique value that may be used to obtain or access the data of an image file.

In other embodiments, system 100 may record the transactions of image captures or scan jobs of documents by imaging device 10 in blockchain 114. The actions taken within system 100 may be transactions that recorded using a distributed ledger 112, disclosed in greater detail below. System 100 may use blockchain 114 to keep track and manage captured data as generated. System 100 also may use the transactions recorded in blockchain 114 to determine costs and record payments within organizations or to users of system 100.

Blockchain 114 may be a continuously growing list of records, called blocks, which are linked and secured, for example, using cryptography. Each block typically contains a cryptographic hash of the previous block, a timestamp, and transaction data. Blockchain 114 may be resistant to modification of the data within its blocks. Blockchain 114 may be an open, distributed ledger that record transactions, such as documents, print jobs, copy jobs, send jobs, and scan jobs, in a verifiable and permanent manner. For use as distributed ledger 112, blockchain 114 may be managed by a peer-to-peer network collectively adhering to a protocol for inter-node communications and validating new blocks. Once recorded, the data in any given block may not be altered retroactively without the alteration of all subsequent blocks, which requires the collusion of the majority of the printing device, or nodes, within system 100.

Blockchain 114 may be secure to allow a decentralized consensus to be achieved. This feature makes blockchain techniques useful for image processing operations within system 100, such as the recording of documents, data, transactions such as image capture and scan jobs, and other records management activities. Devices within system 100 may monitor blockchain transactions to identify processing jobs, essentially making a printing device or a server configure as a proactive entity look for work. For example, a transaction within a block of blockchain 114 may indicate a captured image is created and provide its location within system 100. The blockchain transaction may contain a discrete portion of the captured image for immediate testing against the printing device's stored keys. The encryption of a print job of data 108 may encrypt the documents within the print job, although some print job data may remain unencrypted.

System 100 uses distributed ledger 112 or blockchain 114. One or more distributed ledgers 112 may be used to record various transactions or documents within system 100. While a single common ledger 112 is shown in FIG. 1A, some embodiments may include multiple different ledgers used in connection with system 100. For example, different ledgers may be used for different organizations or users of system 100. Different ledgers also may be used for different roles, such as captured photos versus scanned documents. Ledger 112 may be public, private, permissioned, or secured. In some embodiments, system 100 may be publicly accessible and include printing devices in the public domain, while a subset of entities using the system may maintain one or more private ledgers to which transactions involving the subset of entities are recorded. In other embodiments, all transactions related to system 100, or a particular imaging device, may be recorded in ledger 112. Alternatively, some transactions or data associated with transactions may be recorded off-chain.

For example, the creation of data, such as an image file or scanned document, may be captured. The data associated with these items may be recorded on ledger 112 or added to blockchain 114. A hash value for the item may be created and written to ledger 112, along with other related data, such as date, time, transaction identifier, related or relevant parties to the item, and the like. The hash value allows anyone to confirm the authenticity of the digital documentation by re-hashing the asset wherever it is stored. If the hash values match, then it can be ensured that not a single bit of data of the digital documentation is altered.

Distributed ledger 112 is an electronic ledger that may be stored and maintained by various components within system 100. Referring to FIG. 1A, distributed ledger 112 may be located on imaging device 10 and printing device 104 as well as server 106. In other embodiments, ledger 112 may only be on server 106 or not on the server at all. It may be maintained by any number of one or more devices within system 100. Further, ledger 112 may comprise an existing or general purpose distributed ledger. Alternatively, ledger 112 may be specific to system 100 such that operations between the devices are stored and maintained only by devices within system 100.

In the disclosed embodiments, ledger 112 will maintain the same records throughout system 100. For example, ledger 112 on printing device 104 should match ledger 112 on imaging device 10. Ledger 112 may verify its data by determining the current state of blockchain 114 to ensure the data results match within ledger locations within system 100. The disclosed embodiments provide protection of data within a ledger or log according to the features set forth below.

FIG. 1B depicts imaging device 10 for use within system 100 according to the disclosed embodiments. In some embodiments, imaging device 10 may be a digital camera. Imaging device 10 includes lens 12 and a flash emitter (not shown) provided in a front surface of the body of imaging device 10. Imaging device 10 may include a universal serial bus (USB) connector 57. A memory card 55 for storing image data is inserted into a card slot within imaging device 10. USB connector 57 transfers the image data in memory card 55 to an external apparatus such as a computer, server 106, or printing device 104.

A mode switching dial 21 and multifunction key 22 are provided on imaging device 10. Mode switching dial 21 switches between operation modes of imaging device 10, such as a taking mode for recording the image in memory card 55, a reproducing mode for reproducing the recorded image stored in memory card 55, and a set-up mode for performing various functions. Multifunction key 22 is operated to change a function assigned to each operation mode. For example, multifunction key 22 may be operated as a zoom key in the taking mode while operated as a frame switching key in the reproducing mode, and as a cursor moving key on a setting screen in the set-up mode. A power switch 24 is provided on imaging device 10 to turn the device on and off.

A liquid crystal display (LCD) panel 25 is provided on a surface of imaging device 10. Preferably, LCD panel 25 is located on a rear surface of the imaging device and displays the image, a set-up menu, and the like. In the taking mode, LCD panel 25 is operated as an electronic viewfinder for displaying a through-the-lens image of a subject in real time, while in the reproducing mode, it is operated as a reproduction monitor on which the image recorded in memory card 55 is reproduced and displayed. In the set-up mode, various setting screens are displayed on LCD panel 25. A touch panel 56 is provided for inputting an operation signal to imaging device 10.

A charge-coupled device (CCD) 40 is provided behind lens 12. CCD 40 includes an imaging surface on which subject light passing through lens 12 is focused, and converts the subject light received in the imaging surface into electric signals. CCD 40 is driven by a timing generator (TG) 42. A system controller 41 controls the overall operation of imaging device 10 in response to the operation signal.

In the taking mode, system controller 41 controls timing generator 42 to generate time signal (clock pulse). CCD 40 is driven by the timing signal (clock pulse) input from timing generator 42. The image signal output from CCD 40 is input in a correlation double sampling circuit (CDS) 43 to be sampled. The image signal output from CDS 43 is amplified by an amplifier 44 and then converted into digital image data by an analog/digital converter 45. The image data is temporarily stored in an internal memory 48 by image input controller 46. An image signal processor 51 accesses the image stored in internal memory 48 to apply various kinds of image processing including gradation conversion, white-balance correction, and y-correction processing. A YC conversion processor 52 converts the image data to which the image processing is applied into a luminance signal Y and color difference signals, Cr, Cb.

In the taking mode, CCD 40 images the subject at a predetermined frame rate. The image processing is applied to the obtained image data. The image data is displayed on LCD panel 25 as the live image. LCD panel 25 is driven by an LCD driver 49. LCD driver 49 is provided with an image memory and a digital/analog converter. The processed image data temporarily accumulated in the image memory is converted into, for example, an NTSC analog signal by the D/A converter to be output to LCD panel 25.

When a releasing operation is performed, CCD 40 obtains main image data that has more pixels than the displayed live image. The image processing is applied to the main image data, and, in addition, compression processing of a predetermined compression format, such as the JPEG format, is applied thereto. The main image data to which the compression processing is applied is recorded in memory card 55 through a media controller 54.

In the reproducing mode, the main image data read out from memory card 54 is written into internal memory 48. Then, after expansion processing is applied to the main image data by a compression and expansion processing circuit 53, the image data is output to LCD driver 49 to be reproduced and displayed on LCD panel 25. System controller 41 controls the display posture and size of the image through LCD driver 49. Touch panel 56 is operated for inputting the operation signal to system controller 41 together with multifunction key 22.

As disclosed above, imaging device 10 may be a camera to take pictures. Imaging device 10 also may be a component within another device, such as a mobile device, computing device, scanning device, and the like. As image data is processed as disclosed above, entries may be made into ledger 112 for each file of image data generated. The file may be sent using a block within blockchain 114 to other components within system 100, such as printing device 104 or server 106. The disclosed embodiments process the image files as disclosed below to reduce the processing demands on imaging device 10.

Imaging device 10 also includes network communication interface 58 to connect and exchange data over network 102 to other devices within system 100. Communication interface 58 may be a transmission port within imaging device 10. Communication interface 58 also may be a network port having a network address from communication within system 100. Imaging device 10 may use network communication interface 58 to send and receive data within system 100, including information within distributed ledger 112.

FIG. 1C depicts blocks and entries in a distributed ledger 112 according to the disclosed embodiments. Distributed ledger 112 may receive entries generated by imaging device 10. The blocks and entries are shown as blockchain 114. It should be noted that ledger 112 and blockchain 114 may refer to the same item but the terms are used interchangeably herein. In some embodiments, ledger 112 may refer to the blockchain distributed within system 100 while blockchain 114 may be used to indicate the blocks and data therein. In a log or similar set of incremental entries, such as those in ledger 112, tampering may be detected. The disclosed embodiments provide a more limited form of blockchain by constraining how many hashes are included in the data set.

As disclosed below, an entry may be a discrete item in the data, such as an image file or scanned document, within system 100. Data may refer to a sequential set of items generate by imaging device 10, such as data 108 shown above. A block header may be a group of values that define the blockchain. A block may be an entry that contains a blockchain block header. Finalized data may refer to data written to disk as a complete file or sent as a unit over the network.

According to the disclosed embodiments, each chain hash is generated from hashing the previous block's block header and the data of all entries following that block. This feature may obviate the need for creating a block header for every entry in the data. This process, however, does not obviate the need for hashing every entry in the data. It may be anticipated that the hashing can be deferred if entries are being added too quickly within system 100 for the hashing to be done as quickly as needed. At a later point, there will be sufficient processing time or some time-limit threshold will be exceeded such that the hash will be generated nonetheless.

Referring to FIG. 1C, blockchain 114 includes blocks 150 and 170. Block 170 may be created subsequent to block 150 and include data therefrom in accordance with the functions disclosed below. Block 150 includes block header 151. Block header 151 includes a group of values that define block 150. These values may include header 154, chain hash 156, timestamp 158, and data hash 160. These values are disclosed in greater detail below. Block 150 also may include data field 152, which includes data 153 within the block. Data 153 may include one or more data 108. Data 153 may include image files or documents generated by imaging device 10. Data 153 also may be transactions for data captured by imaging device 10. Data 153 may be specific to that block in that it reflects data generated for ledger 112 to reflect these data files generated by imaging device 10 at the time or date provided by timestamp 158.

Block 170 may include the same features as block 150. Block 170 includes block header 171 that includes header 174, chain hash 176, timestamp 178, and data hash 180 that define the block. Block 170 also includes data field 172 with data 173. Preferably, data 173 differs from data 153 in block 150. Block 170, however, includes data that indicates that it was created with data from block 150, in accordance with normal blockchain operations. Data 173 also may include one or more data 108.

FIG. 1C also includes entries 162, 164, 166, and 168, which reflect discrete items of data generated by imaging device 10 hosting ledger 112. Entries 162-168 may be image files of pictures captured by imaging device 10. They also may be scanned documents generated by one or more printing devices 104. In other embodiments, entries 162-168 may be transactions of image files processed by imaging device, a scanning device, or a subset of the scanning devices. Data for the entries preferably are generated by imaging device 10.

Block 150 may be denoted as entry M in ledger 112. Entry 162 may be the next piece of data received as entry M+1. Entry 162 may include data for an image file or transaction in imaging device 10. Entry 164 is then received as entry M+2. Entries 166 may represent a number of entries received, with the number being shown as P. If 10 entries are received after entry 164, then P is 10. Entries 166 also include data. Entry 168 is the entry received before the generation of block 170. In the disclosed embodiments, a condition occurs, or is met, that causes the generation of block 170 instead of continuing to receive entries. The condition, for example, may be the total number of entries received that causes a block to be generated. The condition also may be related to the amount of data received. After a specified amount of data is received with the entries, a new block is generated. Thus, a block is not generated every time an entry having data is received but, instead, when a condition is met.

The disclosed embodiments generate chain hash 156 or 176 from hashing the previous block's header and the data of all entries following that block. Chain hash 176, for example, is generated from hashing header 154 and the data of entries 162-168. This feature obviates the need to create a block header for every entry received, or for every image file or transaction within imaging device 10. The disclosed embodiments, however, do not obviate the need for hashing every entry in the data. Instead, this hashing may be deferred if entries are being added to quickly for the hashing to be done as quickly as needed. At a later point, there will be sufficient processing time or some threshold, or condition, will be met so that the hash is generated. For example, if the condition is a threshold, then the hashing is performed when a limit will be exceeded upon receipt of an additional entry.

A hash may be defined at a fixed length value that is derived from a variable length set of data. Referring to FIG. 1C, entry 162 may have less amount of data than entries 164 and 168. Entry 164 may have the most amount of data, as shown. Preferably, a secure hashing algorithm (SHA) may be used. A SHA is a cryptographic hash function that takes an input and produces a fixed hash value known as a message digest. It works by transforming the data using the hash function. The hash function may implement an algorithm that includes bitwise operations, modular additions, and compression functions.

The SHA is used to mathematically collapse a variable amount of data into a fixed set of bits, such as 128 bits. Multiple sets of data may be collapsed into the hash to uniquely represent a variable length of data in entries into a fixed number of bits. These also may be known as chained hashes. In some embodiments, SHA-2 may be used as the hash function. SHA-2 hash function may be cumulative in that a separate thread or process can be calculating the partial chain hash of the next block while new entries are being added. In other words, given a typical application programming interface (API) for generating hashes

SHA_INIT( ) may indicate to start a new hash,

SHA_UPDATE( ) may indicate to add data to hash, and

SHA_FINALIZE( ) may indicate to generate the hash result,

with data-to-hash DATA1 and DATA2. The end results of the following two processes of generating the hash result may be similar

Process 1:
SHA _INIT ( )
SHA_UPDATE (DATA1)
SHA_UPDATE (DATA2)
SHA_FINALIZE ( )
Process 2:
SHA_INIT ( )
SHA_UPDATE (DATA1 + DATA2), wherein “+” means concatenation
SHA_FINALIZE

Thus, it is possible for one thread to be calculating the partial hash of DATA1 while another thread is generating the data of DATA2.

Referring to FIG. 1C, a new hash may start after generation of block 150. Data of entry 162 is hashed using the SHA hash function to generate partial chain hash 180. Meanwhile, the data for entry 164 is being created or received in imaging device 10. Data for entry 164 is then added to partial chain hash 180 while data for entries 166 is being created. Partial chain hash 180 is updated accordingly until a condition is met upon receipt of entry 168. The finalize step above causes the disclosed embodiments to generate the hash result as chain hash 176 when block 170 is generated. The disclosed embodiments, therefore, reduce processing requirements by implementing partial chain hash 180 in adding entries with data to ledger 112.

If chain hash 176 of block 170 is incorrect, then one or more of the entries between block 150 and block 170 may have been tampered with. It may not be possible to say which entry is tampered with. Incidentally, if all entries are blocks, then this becomes a normal blockchain that will allow the disclosed embodiments to identify which entry has been modified. This does not prevent tampering while the data within system 100 is being generated or added to partial chain hash 180. Tamper detection may be possible once the data is incorporated into chain hash 176 of block 170. When the set of data is to become finalized data, if the last entry is not already a block, then a block should be added, most likely with no data. Thus, data field 172 may be included by with no data for data 173.

If one wants to verify that the data between block 150 and block 170 has not been tampered with, then the following process may be implemented:

Process 3
SHA_INIT
SHA_UPDATE (Block Header 150)
For each entry from entry M+1 through entry M+P+3 {
SHA_UPDATE (ENTRY)
}
SHA_FINALIZE ( )

The hash value generated should be equal to the value of chain hash 176 in block 170. If it is not, the some of the data in the entries M+1 through M+P+3 have been modified. Because the partial block chain is a concatenation of blocks that can contain intervening entries, by using Process 3, the disclosed embodiments may iterate through the entire blockchain to determine data integrity. If the beginning of the partial block chain is not a block, then the hashing begins at the first entry.

Thus, the disclosed embodiments save on computation requirements in implementing a distributed ledger within imaging device 10 and system 100. Parallel processing also is allowed. The partial chain hash provides the ability to receive entries of data during operations within imaging device 10 without the need to generate a block for each entry. This feature may be desirable when processing a large number of image files, scan jobs, documents, and data in imaging device 10, such as taking a large number of pictures sequentially. The disclosed embodiments may have fewer block headers in ledger 112 than entries. Chain hashes are generated only for blocks, which contain block headers.

As noted above, a condition may invoke the generation of a block when enough entries are received. The condition may be a time period, such as once per hour or every 10 minutes. If no entries are received during the time period, then the generated block may not include data. Another condition may be the number of entries received and added to partial chain hash 180. For example, the number may be 10 such that a block is generated after 10 entries are added to the partial chain hash. Another condition may be the cumulative amount of data received or created. For example, if 10 MB of data is received or created within imaging device 10, then a new block is generated using the partial chain hash of the entries with this data. If processing resources are overburdened for ledger 112, then the disclosed embodiments may wait until the processing resources are available to generate a block. Thus, the disclosed embodiments may invoke the partial chain hash processes disclosed above upon meeting an initial condition.

FIG. 1D illustrates a block diagram of components of printing device 104 according to the disclosed embodiments. The architecture shown in FIG. 1D may apply to any multi-functional printing device or image forming apparatus that performs various functions, such as printing, scanning, storing, copying, and the like. As disclosed above, printing device 104 may send and receive data from imaging device 10 and server 106. Printing device 104 also may include distributed ledger 112.

Printing device 104 includes a computing platform 2201 that performs operations to support these functions. Computing platform 2201 includes a computer processing unit (CPU) 2202, an image forming unit 2204, a memory unit 2206, and a network communication interface 2210. Other components may be included but are not shown for brevity. Printing device 104, using computing platform 2201, may be configured to perform various operations, such as scanning, copying, printing, receiving or sending a facsimile, or document processing. As such, printing device 104 may be a printing device or a multifunction peripheral including a scanner, and one or more functions of a copier, a facsimile device, and a printer. To provide these functions, printing device 104 includes printer components 2220 to perform printing operations, copier components 2222 to perform copying operations, scanner components 2224 to perform scanning operations, and facsimile components 2226 to receive and send facsimile documents. CPU 2202 may issue instructions to these components to perform the desired operations. Operation of these components may generate transactions or data to be added to ledger 112 as entries, disclosed above. Scanner components 2224 may include imaging device 10, as disclosed above.

Printing device 104 also includes a finisher 2211 and one or more paper cassettes 2212. Finisher 2211 includes rotatable downstream rollers to move papers with an image formed surface after the desired operation to a tray. Finisher 2211 also may perform additional actions, such as sorting the finished papers, binding sheets of papers with staples, doubling, creasing, punching holes, folding, and the like. Paper cassettes 2212 supply paper to image the various components 2220, 2222, 2224, and 2226 to create the image formed surfaces on the papers. Paper cassettes 2212 may include papers having various sizes, colors, composition, and the like. Paper cassettes 2212 may be removed to refill as needed.

Document processor input feeder tray 2230 may be the physical components of printing device 104 to receive papers and documents to be processed. A document is placed on or in document processor input feeder tray 2230, which moves the document to other components within printing device 104. The movement of the document from document processor input feeder tray 2230 may be controlled by the instructions input by the user. For example, the document may move to a scanner flatbed for scanning operations. Thus, document processor input feeder tray 2230 provides the document to scanner components 2220. As shown in FIG. 1D, document processor input feeder tray 2230 may interact with engine firmware 2260 to perform the desired operations.

Memory unit 2206 includes memory storage locations 2214 to store instructions 2215. Instructions 2215 are executable on CPU 2202 or other processors associated with printing device 104, such as any processors within components 2220, 2222, 2224, or 2226. Memory unit 2206 also may store information for various programs and applications, as well as data specific to printing device 104. For example, a storage location 2214 may include data for running an operating system executed by computing platform 2201 to support the components within printing device 104. According to the disclosed embodiments, memory unit 2206 may store the tokens and codes used in performing operations for printing device 104. Memory unit 2206 also may store ledger 112 and its associated blocks.

Memory unit 2206 may comprise volatile and non-volatile memory. Volatile memory may include random access memory (RAM). Examples of non-volatile memory may include read-only memory (ROM), flash memory, electrically erasable programmable read-only memory (EEPROM), digital tape, a hard disk drive (HDD), or a solid-state drive (SSD). Memory unit 2206 also includes any combination of readable or writable volatile memories or non-volatile memories, along with other possible memory devices.

Computing platform 2201 may host one or more processors, such as CPU 2202. These processors are capable of executing instructions 2215 stored at one or more storage locations 2214. By executing these instructions, the processors cause printing device 104 to perform various operations. The processors also may incorporate processing units for specific purposes, such as application-specific integrated circuits (ASICs) and field programmable gate arrays (FPGAs). Other processors may be included for executing operations particular to components 2220, 2222, 2224, and 2226. In other words, the particular processors may cause printing device 104 to act as a printer, copier, scanner, and a facsimile device or, in some embodiments, imaging device 10.

Printing device 104 also includes an operations panel 2208, which may be connected to computing platform 2201. Operations panel 2208 may include a display unit 2216 and an input unit 2217 for facilitating interaction with a user to provide commands to printing device 104. Display unit 2216 may be any electronic video display, such as a liquid crystal display (LCD). Input unit 2217 may include any combination of devices that allow users to input information into operations panel 2208, such as buttons, a touch screen, a keyboard or keypad, switches, dials, and the like. Preferably, input unit 2217 includes a touch-screen digitizer overlaid onto display unit 2216 that senses touch to receive inputs from the user. By this manner, the user interacts with display unit 2216. Using these components, one may enter codes or other information into printing device 104.

Printing device 104 also includes network communication processing unit 2218. Network communication processing unit 2218 may establish a network communication using network 102, such as a wireless or wired connection with one or more other image forming apparatuses or server 106. CPU 2202 may instruct network communication processing unit 2218 to transmit or retrieve information over a network using network communication interface 2210. As data is received at computing platform 2201 over a network, network communication processing unit 2218 decodes the incoming packets and delivers them to CPU 2202. CPU 2202 may act accordingly by causing operations to occur on printing device 104. CPU 2202 also may retrieve information stored in memory unit 2206, such as settings for printing device 104.

Printing device 104 also includes engine 2260. Engine 2260 may be a combination of hardware, firmware, or software components that act accordingly to accomplish a task. For example, engine 2260 is comprised of the components and software to print a document. It may receive instructions from computing platform 2201 after user input via operations panel 2208. Alternatively, engine 2260 may receive instructions from other attached or linked devices.

Engine 2260 manages and operates the low-level mechanism of the printing device engine, such as hardware components that actuate placement of toner onto paper. Engine 2260 may manage and coordinate the half-toner, toner cartridges, rollers, schedulers, storage, input/output operations, and the like. Raster image processor (RIP) firmware 2290 that interprets the page description languages (PDLs) would transmit and send instructions down to the lower-level engine 2260 for actual rendering of an image and application of the toner onto paper during operations on printing device 104.

Printing device 104 may include one or more sensors 2262 that collect data and information to provide to computing platform 2201 or CPU 2202. Each sensor 2262 may be used to monitor certain operating conditions of printing device 104. Sensors 2262 may be used to indicate a location of a paper jam, failure of hardware or software components, broken parts, operating system problems, document miss-feed, toner level, as well as other operating conditions. Sensors 2262 also may detect the number of pages printed or processed by printing device 104, or the print volume of the printing device over a period of time or other criteria. When a sensor 2262 detects an operational issue or failure event, it may send a signal to CPU 2202. CPU 2202 may generate an error alert associated with the problem. The error alert may include an error code. Computing platform 2201 may transmit the error alert along with the error code to server 106. In some embodiments, the error codes or messages may be stored in a ledger 112 generated according to the disclosed embodiments. The error data is received as entries to ledger 112.

Display unit 2216 may display information about applicable error codes and a short description of the error associated with the operational issue or failure event. Further, display unit 2216 may display an instruction on how to proceed (operate) to resolve the error. For example, if a network error occurred, then the following message may be provided on operations panel 2208: Reboot the device.

Some errors have hardware-related causes. For example, if a failure occurred in finisher 2211, such as a paper jam, display unit 2216 may display information about the error and the location of the failure event, or the finisher. In the instance when the paper jam occurs in paper cassettes 2212, display unit 2216 displays the information about the jam error as located in one of the paper cassettes.

Some errors have a type of firmware-related cause. For example, network communication processing unit 2218 may cause a firmware or software error. Display unit 2216 may display the firmware-related error, any applicable error codes, and provide recommendations to address the error, such as reboot the device.

Referring to FIG. 1A above, print jobs for image files generated by imaging device 10 may be provided to printing device 104 using distributed ledger 112. As blocks are generated, the image file data is provided in the blocks to distributed ledger 112. As ledger 112 is updated with the new block, printing device 104 determines the new block is received and processes the print jobs for the image files corresponding to the new block.

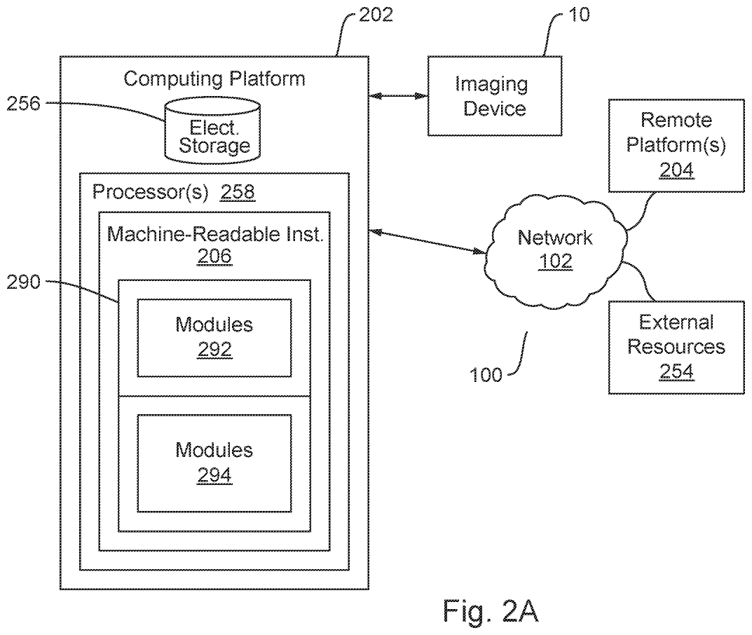

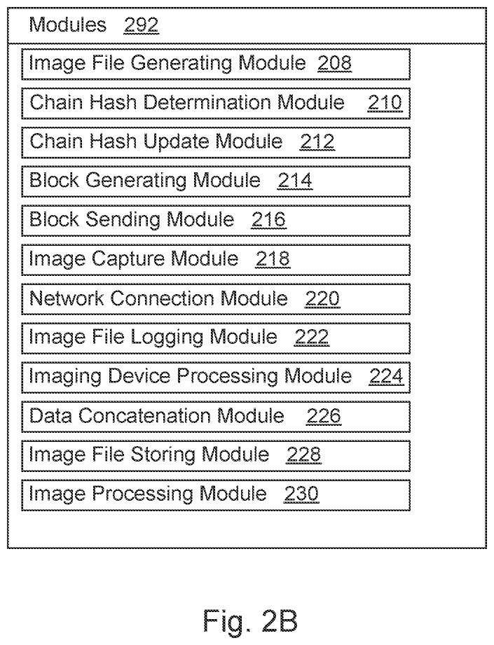

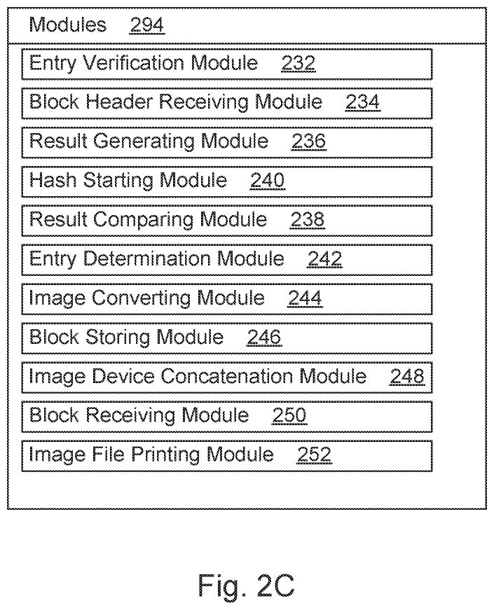

FIGS. 2A-C illustrate a computing platform 202 having modules 290 configured for processing entries in a distributed ledger 112 for imaging device 10 according to the disclosed embodiments. In some implementations, system 100 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures.

Computing platform(s) 202 may be configured by machine-readable instructions 206. Machine-readable instructions 206 may include one or more instruction modules. The instruction modules may include computer program modules 290. Computing platform(s) 202 may be connected to imaging device 10 either directly or through network 102. In some embodiments, computing platform(s) 202 may be a component within imaging device 10 to facilitate the processing of entries for image files within ledger 112. In other embodiments, computing platform(s) may be part of server 106 that executes the functions disclosed below.

Machine-readable instructions 206 may include one or more instruction modules. The instruction modules may include computer program modules 290. FIGS. 2B and 2C show modules 290 in greater detail as set of modules 292 and set of modules 294. The instruction modules may include one or more of image file generating module 208, chain hash determination module 210, chain hash update module 212, block generating module 214, block sending module 216, image capture module 218, network connection module 220, image file logging module 222, imaging device processing module 224, data concatenation module 226, image file storing module 228, image processing module 230, entry verification module 232, block header receiving module 234, result generating module 236, result comparing module 238, hash starting module 240, entry determination module 242, image converting module 244, block storing module 246, imaging device connection module 248, block receiving module 250, image file printing module 252, and/or other instruction modules.

Image file generating module 208 may be configured to generate a first image file using imaging device 10. The first image file may include data. The first image file may be shown as entry 162, disclosed above. Imaging device 10 may generate an image file by capturing a picture or scanning a document. Image file generating module 208 may be configured to generate at least one additional image file, treated as subsequent entries to blockchain 114, having data using the imaging device. For example, image file generating module 208 may be configured to generate the first image file and a second image file of the at least one additional image file using the imaging device. The first and second image files may include data. The data for the image files may include metadata for each image file. Metadata may be data in addition to that captures by imaging device 10, such as date/time, parameters of the file, name/title, and the like.

Chain hash determination module 210 may be configured to determine a partial chain hash 180 using the data for the first image file, or entry 162. In some embodiments, Chain hash determination module 210 may be configured to determine a partial chain hash 180 using the concatenated data of more than one image file, or entry. Chain hash determination module 210 may be configured to determine a partial chain hash 180 of the first block header, or block header 151 of block 150. The determination of partial chain hash 180 may include collapsing the data for the image files and block header 151 into 128 bits to unique represent a variable length of data into a fixed number of bits.

Chain hash update module 212 may be configured to update partial chain hash 180 with the data of the at least one additional image file. Chain hash update module 212 also may be configured to update the partial chain hash with data of subsequent image files. Chain hash update module 212 may be configured to update the partial chain hash with the data of at least one entry related to the additional image file. The at least one entry may include a set of entries used to generate the partial chain hash. Chain hash update module 212 may be configured to update the partial chain hash with each entry of the at least one entry.

Block generating module 214 may be configured to generate a block 170 having a block header 171 for a blockchain using partial chain hash 180 when a condition is met. The condition may include a number of image files that equals a set value. The condition may include the partial chain hash reaching a set size of data. The condition may include that a period of time has elapsed from receiving the image file, or entry 162. Generating the block may include hashing a block header for a previous block with the partial chain hash. The condition may include that a number of entries processed into partial chain hash 180 equals a set value. The condition also may include the number of entries exceeds a set value. The condition also may include the partial chain hash reaching a set size of data. Block generating module 214 may be configured to generate the block based on the size of the memory within imaging device 10. The image files may be transactions within the block such that the condition is related to the number of transactions incurred by imaging device 10.

Block sending module 216 may be configured to send the block from imaging device 10 over a network 102. For example, block 170 may be sent from imaging device 10 over network 102 to printing device 104. Imaging device 10 may use a network communication interface 58 connected to network 102 to do so. Alternatively, imaging device 10 may include USB connector 57 to connect to a device to send blocks over network 102.

Image capture module 218 may be configured to capture an image with imaging device 10. For example, image capture module 218 may be configured to capture a first image for a first image file, shown as entry 162, and a second image for a second image file, such as entry 164. Image capture module 218 may configure imaging device 10 to capture images that become image files using the embodiments shown in FIG. 1B. Lens 12 and CCD 40 may be used to capture an image that is treated as an entry for blockchain 114.\

Network connection module 220 may be configured to connect to network 102 after a block is generated. For example, network connection module 220 may cause imaging device 10 to connect to network 102 after block 170 is generated for distributed ledger 112. Image file logging module 222 may be configured to log the image files as transactions within a block on distributed ledger 112. Image device processing module 224 may be configured to process images captured by imaging device 10 using a processor thereon. Data concatenation module 226 may be configured to concatenate the data for the captured first and second images for processing into partial chain hash 180.

Image file storing module 228 may be configured to store the first image file and the second image file in a memory, such as memory 48, on imaging device 10. Image file storing module 228 may be configured to store captured images as images files on imaging device 10. Image processing module 230 may be configured to have imaging device 10 process captured images, such as the first and second images, to generate the respective image files.

Entry verification module 232 may be configured to verify entries in distributed ledger 112 or blockchain 114. Block header receiving module 234 may be configured to receive a first block header 151 of a first block 150. Result generating module 236 may be configured to generate chain hash 176 after processing last entry 168 of entries received for inclusion in block 170. Result comparing module 238 may be configured to compare the hash result of partial chain hash 180 to a chain hash value for chain hash 176 of block 170 to verify the data for entries 162-168. This module also may determine a number for the set of entries received according and processed according to a condition to generate block 170, as disclosed above.

Hash starting module 240 may be configured to start a new hash for partial chain hash 180 upon receipt of block 170 in distributed ledger 112. Entry determination module 242 may be configured to determine that an entry of the entries has been tampered with using partial chain hash 180. Image converting module 244 may be configured to convert images into image files having data within imaging device 10 using a processor. Block storing module 246 may be configured to store a generated block, such as block 150 or 170, in a memory. Imaging device connection module 248 may be configured to connect imaging device 10 to network 102 using network communication interface 58.

Block receiving module 250 may be configured to have printing device 104 receive a block within distributed ledger 112. Image file printing module 252 may be configured to print an image file at printing device 104 within a block logged in distributed ledger 112.

In some implementations, computing platform(s) 202, remote platform(s) 204, and/or external resources 254 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 254 may be operatively linked via some other communication media.

A given remote platform 204 may include one or more processors configured to execute computer program modules. The computer program modules may be configured to enable an expert or user associated with the given remote platform 204 to interface with system 200 and/or external resources 254, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 254 may include sources of information outside of system 100, external entities participating with system 100, and/or other resources. In some implementations, some or all of the functionality attributed herein to external resources 254 may be provided by resources included in system 100.

Computing platform(s) 202 may include electronic storage 256, one or more processors 258, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 256 may comprise non-transitory storage media that electronically stores information. The electronic storage media of electronic storage 256 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 256 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 256 may include one or more virtual storage resources (e.g., cloud storage, a virtual private network, and/or other virtual storage resources). Electronic storage 256 may store software algorithms, information determined by processor(s) 258, information received from computing platform(s) 202, information received from remote platform(s) 204, or other information that enables computing platform(s) 202 to function as described herein.

Processor(s) 258 may be configured to provide information processing capabilities in computing platform(s) 202. As such, processor(s) 258 may include one or more of a digital processor, an analog processor, a digital circuit designed to process information, an analog circuit designed to process information, a state machine, and/or other mechanisms for electronically processing information. Although processor(s) 258 is shown in FIG. 2A as a single entity, this is for illustrative purposes only. In some implementations, processor(s) 258 may include a plurality of processing units. These processing units may be physically located within the same device, or processor(s) 258 may represent processing functionality of a plurality of devices operating in coordination. Processor(s) 258 may be configured to execute modules 208, 210, 212, 214, 216, 218, 220, 222, 224, 226, 228, 230, 232, 234, 236, 238, 240, 242, 244, 246, 248, 250, or 252, or other modules. Processor(s) 258 may be configured to execute modules 208, 210, 212, 214, 216, 218, 220, 222, 224, 226, 228, 230, 232, 234, 236, 238, 240, 242, 244, 246, 248, 250, or 252, or other modules by software; hardware; firmware; some combination of software, hardware, or firmware; or other mechanisms for configuring processing capabilities on processor(s) 258. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 220, 222, 224, 226, 228, 230, 232, 234, 236, 238, 240, 242, 244, 246, 248, 250, and/or 252 are illustrated in FIGS. 2A-C as being implemented within a single processing unit, in implementations in which processor(s) 258 includes multiple processing units, one or more of modules 208, 210, 212, 214, 216, 218, 220, 222, 224, 226, 228, 230, 232, 234, 236, 238, 240, 242, 244, 246, 248, 250, or 252 may be implemented remotely from the other modules. The description of the functionality provided by the different modules 208, 210, 212, 214, 216, 218, 220, 222, 224, 226, 228, 230, 232, 234, 236, 238, 240, 242, 244, 246, 248, 250, or 252 described below is for illustrative purposes, and is not intended to be limiting, as any of modules 208, 210, 212, 214, 216, 218, 220, 222, 224, 226, 228, 230, 232, 234, 236, 238, 240, 242, 244, 246, 248, 250, or 252 may provide more or less functionality than is described. For example, one or more of modules 208, 210, 212, 214, 216, 218, 220, 222, 224, 226, 228, 230, 232, 234, 236, 238, 240, 242, 244, 246, 248, 250, or 252 may be eliminated, and some or all of its functionality may be provided by other ones of modules 208, 210, 212, 214, 216, 218, 220, 222, 224, 226, 228, 230, 232, 234, 236, 238, 240, 242, 244, 246, 248, 250, or 252. As another example, processor(s) 258 may be configured to execute one or more additional modules that may perform some or all of the functionality attributed below to one of modules 208, 210, 212, 214, 216, 218, 220, 222, 224, 226, 228, 230, 232, 234, 236, 238, 240, 242, 244, 246, 248, 250, or 252.

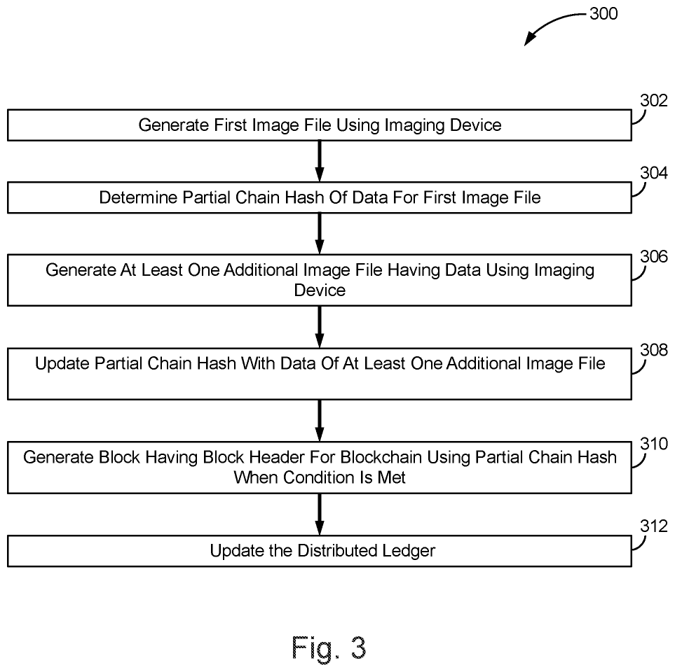

FIG. 3 depicts a flowchart 300 for processing entries in a distributed ledger 112 for a printing system 100 according to the disclosed embodiments. Flowchart 300 may refer to features disclosed in FIGS. 1-2C for illustrative purposes. The embodiments of flowchart 300, however, are not limited to the features of FIGS. 1-2C. Flowchart 300 may be implemented in one or more processing devices (e.g., a digital processor, an analog processor, a digital circuit designed to process information, an analog circuit designed to process information, a state machine, or other mechanisms for electronically processing information). The one or more processing devices may include one or more devices executing some or all of the operations of flowchart 300 in response to instructions stored electronically on an electronic storage medium. The one or more processing devices may include one or more devices configured through hardware, firmware, or software to be specifically designed for execution of one or more of the operations of flowchart 300.

An operation 302 may include generating a first image file using imaging device 10. The first image file may include data. The first image file may be shown as entry 162 in FIG. 1C. Operation 302 may be performed by one or more hardware processors configured by machine-readable instructions including a module that is the same as or similar to image file generating module 208, in accordance with one or more implementations. An operation 304 may include determining a partial chain hash 180 of the data for the first image file. Operation 304 may be performed by one or more hardware processors configured by machine-readable instructions including a module that is the same as or similar to chain hash determination module 210, in accordance with one or more implementations.

An operation 306 may include generating at least one additional image file having data using imaging device 10. The additional image file may be shown as entry 164 in FIG. 1C. As shown, entry 164 may not have the same amount of data as entry 162. Thus, the additional image file may be a different size than the first image file. Operation 306 may be performed by one or more hardware processors configured by machine-readable instructions including a module that is the same as or similar to image file generating module 208, in accordance with one or more implementations.

An operation 308 may include updating partial chain hash 180 with the data of the at least one additional image file. The data for the additional image file, or entry 164 may be hashed using a secure hash algorithm, as disclosed above. This data may be added to the data already within partial chain hash 180. Operation 308 may be performed by one or more hardware processors configured by machine-readable instructions including a module that is the same as or similar to chain hash update module 212, in accordance with one or more implementations.

An operation 310 may include generating a block 170 having a block header 171 for a blockchain using partial chain hash 180 when a condition is met. Block header 171 may include chain hash 176 of partial chain hash 180 and block header 151 of previous block 150. The image files may be entries within the block. Operation 310 may be performed by one or more hardware processors configured by machine-readable instructions including a module that is the same as or similar to block generating module 214, in accordance with one or more implementations.

An operation 312 may include updating distributed ledger 112 associated with imaging device 10 with block 170. Operation 312 may be performed by one or more hardware processors configured by machine-readable instructions including a module that is the same or similar to block sending module 216, in accordance with one or more implementations.

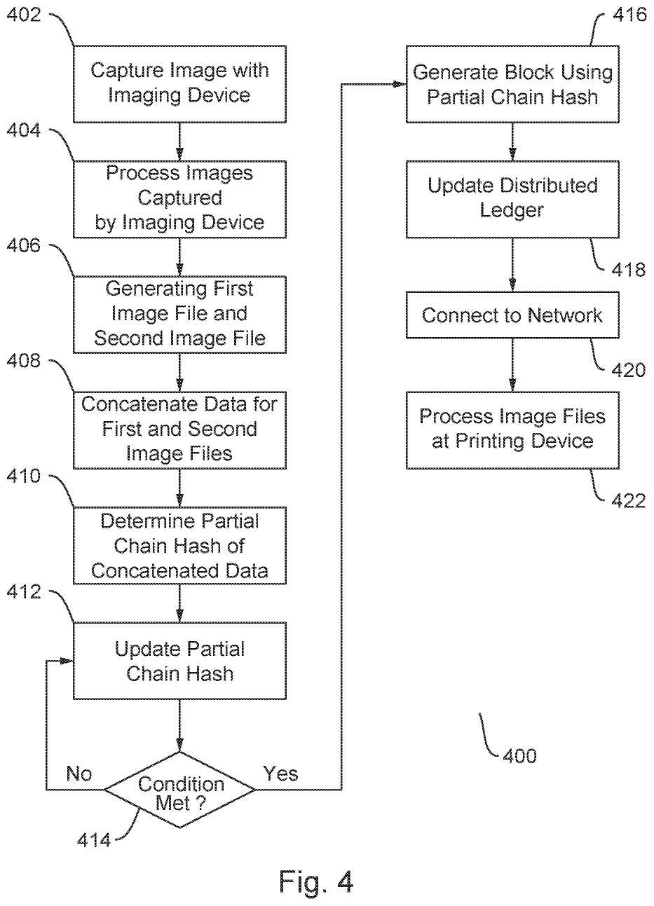

FIG. 4 depicts a flowchart 400 for processing entries in a distributed ledger 112 for a printing system 100 according to the disclosed embodiments. Flowchart 400 may refer to features disclosed in FIGS. 1-3 for illustrative purposes. The embodiments of flowchart 400, however, are not limited to the features of FIGS. 1-3. Flowchart 400 may be implemented in one or more processing devices (e.g., a digital processor, an analog processor, a digital circuit designed to process information, an analog circuit designed to process information, a state machine, or other mechanisms for electronically processing information). The one or more processing devices may include one or more devices executing some or all of the operations of flowchart 400 in response to instructions stored electronically on an electronic storage medium. The one or more processing devices may include one or more devices configured through hardware, firmware, or software to be specifically designed for execution of one or more of the operations of flowchart 400.

An operation 402 may include capturing an image with imaging device 10. Imaging device 10 may use lens 12 and CCD 40 capture the image. Operation 402 may be performed by one or more hardware processors configured by machine-readable instructions including a module that is the same as or similar to image capture module 218, in accordance with one or more implementations. An operation 404 may include processing images captured by the imaging device using the processor. Images may be processed into image files for use within system 100. Operation 404 may be performed by one or more hardware processors configured by machine-readable instructions including a module that is the same as or similar to imaging device processing module 224, in accordance with one or more implementations.

An operation 406 may include generating the first image file and a second image file of the image files using the imaging device. The first image file may correspond to a first image captured by imaging device 10. The second image file may correspond to a second image captured by imaging device 10. The first and second image files may include data as well as metadata about the image files. Operation 406 may be performed by one or more hardware processors configured by machine-readable instructions including a module that is the same as or similar to image file generating module 208, in accordance with one or more implementations.

An operation 408 may include concatenating the data for the first and second image files. Operation 408 may be performed by one or more hardware processors configured by machine-readable instructions including a module that is the same as or similar to data concatenation module 226, in accordance with one or more implementations. An operation 410 may include determining a partial chain hash 180 of the concatenated data. Image files may be treated as entries into blockchain 114. Operation 410 may be performed by one or more hardware processors configured by machine-readable instructions including a module that is the same as or similar to chain hash determination module 210, in accordance with one or more implementations.

An operation 412 may include updating partial chain hash 180 with data of a subsequent image file generated by imaging device 10. Operation 412 may be performed by one or more hardware processors configured by machine-readable instructions including a module that is the same as or similar to chain hash update module 212, in accordance with one or more implementations. An operation 414 may include determining whether a condition is met by the data of the image files in partial chain hash 180. Operation 414 may be performed by one or more hardware processors configured by machine-readable instructions including a module that is the same or similar to chain hash determination module 210, in accordance with one or more implementations.

If operation 414 is no, then flowchart 400 returns to operation 412 to receive and update partial chain hash 180 with another subsequent image file. If operation 414 is yes, then an operation 416 may include generating block 170 having block header 171 for the blockchain using partial chain hash 180 when the condition is met. Each image file may be a data entry in the block. Operation 416 may be performed by one or more hardware processors configured by machine-readable instructions including a module that is the same as or similar to block generating module 214, in accordance with one or more implementations.

An operation 418 may include updating distributed ledger 112 with block 170. A new partial chain hash 180 may be started to receive image files for the next block. An operation 420 may include connecting imaging device 10 to network 102 after block 170 is generated. Operation 420 may be performed by one or more hardware processors configured by machine-readable instructions including a module that is the same or similar to network connection module 220, in accordance with one or more implementations.

An operation 422 may include processing the image files within block 170 at printing device 104. Distributed ledger 112 may be monitored by printing device 104 to determine when a new block is added to the blockchain. Printing device 104 may then process the image files associated with the new block. For example, printing device 104 may print the images using the data of the image files. Alternatively, server 106 may stores the image files of the new block. For example, if server 106 is a cloud-based server, then the user of imaging device 10 may store the images for retrieval later.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operations, elements, components, and/or groups thereof.

Embodiments may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed above.

The corresponding structures, material, acts, and equivalents of all means or steps plus function elements in the claims below are intended to include any structure, material or act for performing the function in combination with other claimed elements are specifically claimed. The description of the present invention has been presented for purposes of illustration and description, but is not intended to be exhaustive or limited to the invention in the form disclosed. Many modifications and variations will be apparent to those of ordinary skill without departing from the scope and spirit of the invention. The embodiment was chosen and described in order to best explain the principles of the invention and the practical application, and to enable others of ordinary skill in the art to understand the invention for embodiments with various modifications as are suited to the particular use contemplated.

One or more portions of the disclosed networks or systems may be distributed across one or more printing device systems coupled to a network capable of exchanging information and data. Various functions and components of the printing device system may be distributed across multiple client computer platforms, or configured to perform tasks as part of a distributed system. These components may be executable, intermediate or interpreted code that communicates over the network using a protocol. The components may have specified addresses or other designators to identify the components within the network.

It will be apparent to those skilled in the art that various modifications to the disclosed may be made without departing from the spirit or scope of the invention. Thus, it is intended that the present invention covers the modifications and variations disclosed above provided that these changes come within the scope of the claims and their equivalents.

What is claimed is:

1. A method for processing data at an imaging device using a distributed ledger, the method comprising:
generating a first image file using the imaging device, wherein the first image file includes data;
determining a partial chain hash of the data for the first image file;
generating at least one additional image file having data using the imaging device;
updating the partial chain hash with the data of the at least one additional image file;
generating a block having a block header for a blockchain using the partial chain hash when a condition is met, wherein the image files are entries within the block; and
updating the distributed ledger associated with the imaging device with the block.

2. The method of claim 1, further comprising capturing an image with the imaging device.

3. The method of claim 2, further comprising generating the first image file for the image.

4. The method of claim 1, wherein the data for the image files include metadata for each image file.

5. The method of claim 1, wherein the condition includes a number of image files that equals a set value.

6. The method of claim 1, wherein the condition includes the partial chain hash reaching a set size of data.

7. The method of claim 1, wherein the condition includes that a period of time has elapsed from the first generating step.

8. The method of claim 1, wherein generating the block includes hashing a block header for a previous block with the partial chain hash.

9. The method of claim 1, further comprising updating the distributed ledger at a printing device.

10. A method for processing images captured by an imaging device, the method comprising:
generating a first image file and a second image file using the imaging device, wherein the first and second image files include data;
concatenating the data for the first and second image files;
determining a partial chain hash of the concatenated data;
updating the partial chain hash with data of at least one subsequent image file;
generating a block having a block header for a blockchain using the partial chain hash when a condition is met, wherein each image file is an entry within the block;
updating a distributed ledger with the block, wherein the imaging device and a printing device include the distributed ledger; and
processing the image files at the printing device.

11. The method of claim 10, further comprising capturing a first image for the first image file and a second image for the second image file.

12. The method of claim 11, further comprising processing the first and second images to generate the first and second image files, respectively.

13. The method of claim 10, wherein the condition includes a number of entries equals a set value.

14. The method of claim 10, wherein the condition includes the partial chain hash reaching a set size of data.

15. The method of claim 10, wherein the condition includes that a period of time has elapsed from the first generating step.

16. The method of claim 10, wherein generating the block includes hashing a block header for a previous block with the partial chain hash.

17. The method of claim 10, further comprising storing the image files corresponding to the block at the imaging device.

18. An imaging device comprising:
a lens and a charged-coupled device configured to capture images;
a processor to convert the captured images into image files having data; and
a memory to store the image files, wherein the memory also stores instructions to configure the processor to
determine a partial chain hash of the data for a first image file;
generate at least one additional image file having data;
update the partial chain hash with the data of the at least one additional image file;
generate a block having a block header for a blockchain using the partial chain hash when a condition is met, wherein the image files are entries within the block; and
update a distributed ledger associated with the imaging device with the block.

19. The imaging device of claim 18, further comprising a network communication interface to connect to the network.

20. The imaging device of claim 18, wherein the memory has a size for storing image data and the block is generated based on the size of the memory.
